(19) United States
(12) Patent Application Publication
(10) Pub. No.: US 2002/0049799 A1
(43) Pub. Date: Apr. 25, 2002

(54) Parallel implementation for digital infinite impulse response filter

(76) Inventor: Minsheng Wang, Plano, TX (US)

Correspondence Address: TEXAS INSTRUMENTS INCORPORATED, P O BOX 655474, M/S 3999, DALLAS, TX, 75265

(21) Appl. No.: 09/974,029

(22) Filed: Oct. 10, 2001

Related U.S. Application Data
(60) Provisional application No. 60/242,454, filed on Oct. 24, 2000.

(51) Int. Cl. G06F 17/10

(52) U.S. Cl. 708/320

(57) ABSTRACT

An IIR filter implementation which provides equivalent results to prior art IIR filters, yet operates about twice as fast as the prior art IIR filters, or requires about half the gate count of the prior art IIR filters and reduced semiconductor area as compared to prior art IIR filters for equivalent speed of operation. An implementation of a high order IIR filter in accordance with one embodiment of the present invention involves the parallel structure of the second-order IIR filters, therefore the filter operates twice as fast as the prior art filter. In accordance with a second embodiment of the invention, low order filters of the same order are reused (used on a time-sharing basis), thereby requiring only a single IIR filter for each order utilized on a time sharing basis, thereby further reducing the number of gates and semiconductor area required.

### BACKGROUND OF THE INVENTION

1. Field of the Invention

This invention relates generally to digital filters and, more particularly, to a novel implementation for an infinite impulse response (IIR) filter.

2. Brief Description of the Prior Art

Digital filters are well known in the prior art. Such filters receive sampled digital signals and transmit a sampled waveform therethrough. The waveform transmitted by the digital filter is determined by coefficients operating on portions of the transmitted digital signal. A typical prior art digital filter has a plurality of serially connected delay components with outputs of each delay component transmitted both to the succeeding delay component and to a coefficient addition component, the coefficient addition component adding the output from the delay component applied thereto by a weighting factor derived from a transform function. The outputs of the coefficient addition components are applied to the output terminal of the digital filter to provide the filter output signal. Accordingly, an input signal, after an appropriate delay, is filtered according to the coefficient addition components with the resulting signal being applied to the digital filter output.

Digital filters are classified as infinite impulse response (IIR) filters and finite impulse response filters (FIR). The difference is that the transfer function of the IIR is in both the denominator and numerator whereas, for the FIR, the transfer function is in the numerator.

A typical prior art register level implementation for a second-order IIR filter is shown in FIG. 1 and operates in accordance with the equation: H(z)=1/(1+a₁z⁻¹+a₂z⁻²), where H(z)=Y(z)/X(z) is the transfer function of the system and a₁ and a₂ are multiplication coefficients. The term z⁻¹ represents a register unit (such as, for example, a D flip-flop) to store the result of the previous calculation and provides a delay.

With reference to FIG. 1, the major computation is due to the two multiplications, −a₁y(n−1) and −a₂y(n−2). With the help of coefficient encoding, known as canonic signed digits (CSD), the multiplications can be performed in shift and addition. For example, binary 0.011 (⅜) is equivalent to binary 0.1 (½) minus binary 0.001 (⅛), therefore multiplication of y(n−1) by binary 0.011 can be performed by one shift-right (SR) minus three shift-right of y(n−1). Also, nested multiplication (described in a Doctoral Thesis by B. P. Brandt entitled “Oversampled Analog-to-Digital Conversion”, Stanford University, Calif., 1991, the contents of which are incorporated herein by reference) can be used to reduce the round-off noise. The above example of multiplication by binary 0.011 (⅜) can be alternatively performed by subtracting y(n−1) by its two right-shift and then one right-shift of the residue, since (½)y(n−1) −(⅛)y(n−1)=(½)(y(n−1)−(¼)y(n−1)). The advantage of postponing the right-shift to the end is to reduce the round-off noise.

The coefficients a₁ and a₂ must be realized precisely and accurately for IIR filters in order to obtain a good frequency response without limit-cycle effect. The existing implementation using nested multiplication and interleaving is for the purpose of minimizing the quantization noise and to eliminate the limit-cycle effect. The following example illustrates the existing techniques using the transfer function equation set forth above.

Assume −a₁=1+1/512+1/1024 and −a₂=1/16+1/256, then the following four steps calculate −a₁y(n−1)−a₂y(n−2)=y(n) in accordance with the above transfer function equation:

Step 1: r1=y(n−1)+SR(y(n−1),1);

Step 2: r2=y(n−2)+SR(r1,1);

Step 3: r3=y(n−2)+SR(r2,4);

Step 4: r4=y(n−1)+SR(r3,4);

where SR=shift right of the first argument by the amount defined in the second argument, and r1, r2, r3 and r4 are the intermediate result, i.e., the partial summation.

Step 1 uses nested multiplication to calculate (1+½) for 1/512+1/1024 in −a₁. Step 2 adds 1/256 from −a₂ to the result from step 1. Step 3 adds 1/16 from −a₂ to the result from step 2. Step 4 adds 1 from −a₁ to the prior result (the result of step 3) and obtains the final result. It can be seen that the partial multiplication is performed interleavedly from the smallest coefficient between −a₁ and −a₂ to the largest coefficient. Also, nested multiplication is employed to reduce the quantization noise. It should be noted that the above described implementation operates in an inferior manner for high speed applications because of the data dependence of the intermediate result. In Synopsys synthesis, a long critical path is observed from the input to the output, which inevitably slows down the computation. For the simple coefficients a₁ and a₂ in the above example, it takes four addition cycles to obtain the final result. For the practical filter, it usually takes more than ten addition cycles to obtain the result, which limits this technique to high speed applications.

### SUMMARY OF THE INVENTION

In accordance with the present invention, there is provided an IIR filter implementation which provides equivalent results to prior art IIR filters, yet operates at least twice as fast as prior art IIR filters, or requires about half the gate count (i.e., silicon area) of the prior art IIR filters for approximately equal speed of operation. A parallel implementation of a second-order IIR filter in accordance with a first embodiment of the invention operates faster than the conventional serial implementation of the same second-order IIR filter. In accordance with the second embodiment of the invention, a high order filter is implemented using a single lower order filter on a time sharing basis, thereby reducing the number of gates and semiconductor area required.

### BRIEF DESCRIPTION OF THE DRAWING

FIG. 1 is a block diagram of a typical prior art second order IIR filter;

FIG. 2 is a block diagram of a parallel structure IIR filter in accordance with the present invention;

FIG. 3 is a block diagram of an implementation of a high order (seventh order) IIR filter using one or more lower order IIR filters (three second order and one first order IIR filters for the seventh order filter) in accorance with the prior art;

FIG. 4 is a block diagram showing an implementation of the IIR filter of FIG. 3 using a single second order IIR filter which is reused on a time-sharing basis preceded by a decoder in accordance with the second embodiment of the invention;

FIG. 5 is a circuit diagram showing the use of the circuit of FIG. 2 in accordance with the present invention;.

FIG. 6 is a comparison of the performance of the impulse response between the filter in accordance with the present invention and the prior art with the bottom plot showing the low frequency region from which the subject implementation is shown to be closer to ideal response;

FIG. 7 shows the frequency response for a single tone using the filter in accordance with the present invention; and

FIG. 8 shows the frequency response of a discrete multi-tone in accordance with the present invention.

### DESCRIPTION OF THE PREFERRED EMBODIMENT

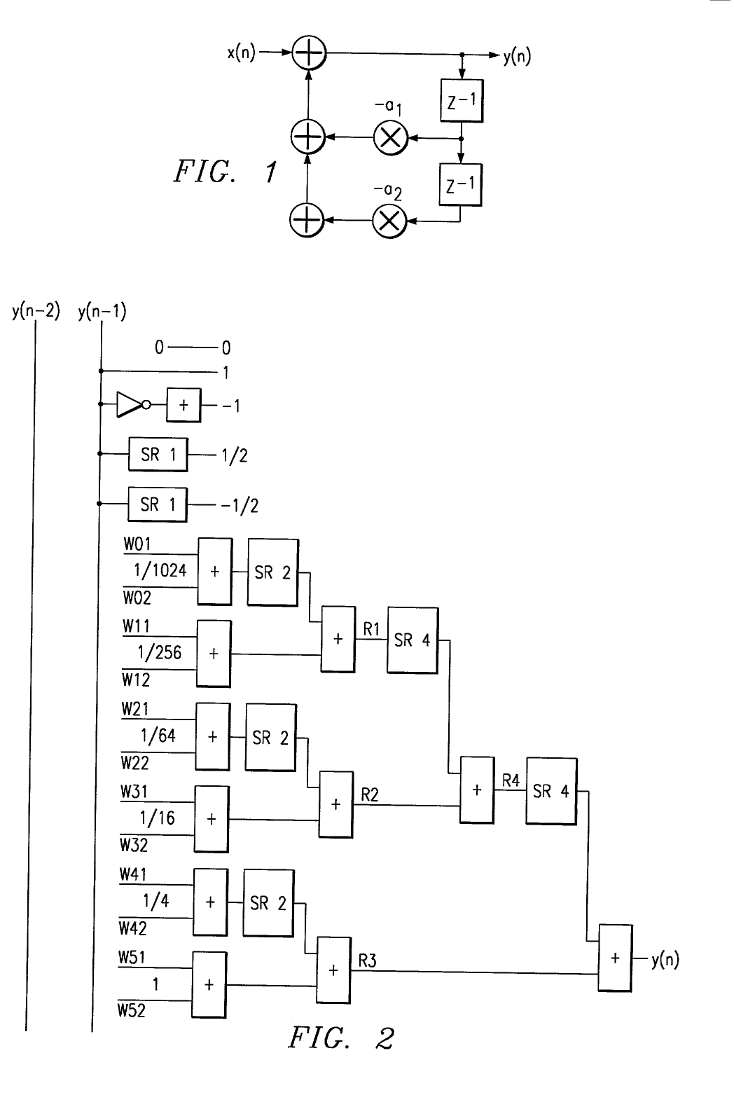

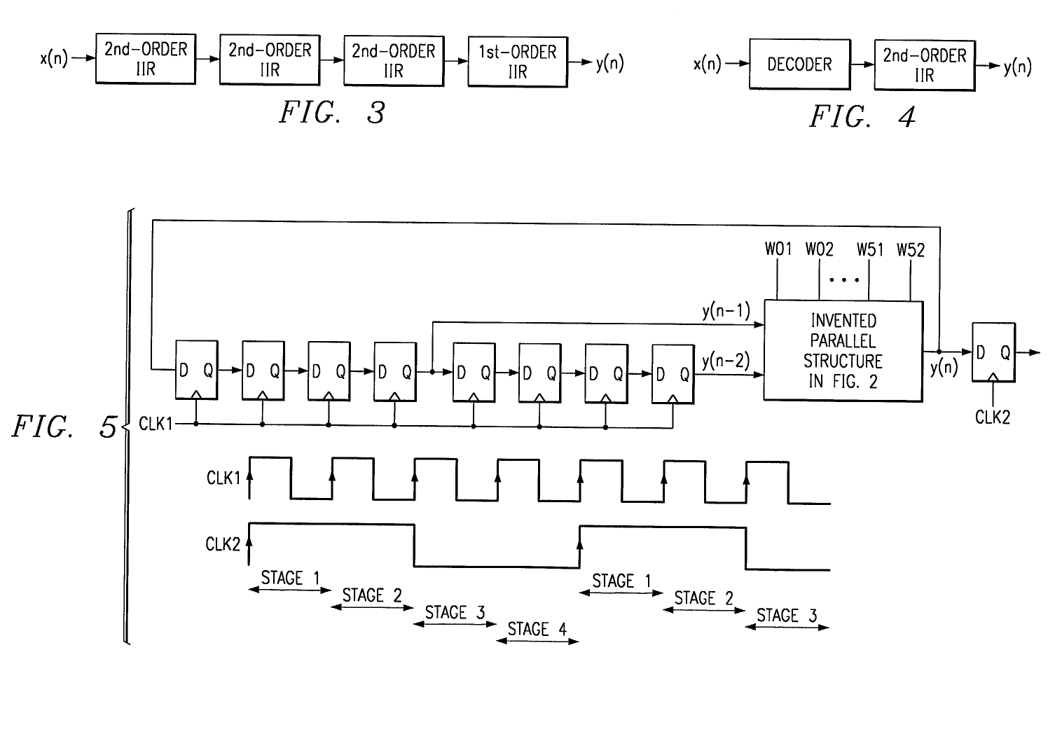

A parallel structure of the invention is shown in FIG. 2. In this embodiment, the adders from the top to the bottom on the left-most column bear different weights varying from 1/1024 to 1 for the two-input pairs Wᵢ1,Wᵢ2, where i=0,1, . . . 5. Depending upon the actual filter coefficients, the two-input Wᵢ1Wᵢ2 is A times y(n−1) and y(n−2), respectively, with A taking values from {0,1, −1,½,−½}, as shown on the left-top of FIG. 2. For example, the coefficients −a₁=1−¼+1/16−1/64+1/512+1/1024 and −a₂=1−1/16+1/64−1/256 corresponding to the following setting:

W01=y(n−1);

W02=zero;

W11=SR(y(n−1), 1);

W12=y(n−2);

W21=−y(n−1);

W22=−y(n−2);

W31=y(n−1);

W32=y(n−2)

W41=−y(n−1);

W42=zero;

W51=y(n−1)

W52=−y(n−2).

It takes four clock-cycles to obtain y(n) with the novel parallel scheme in accordance with the present invention, one clock-cycle for each column of adder as shown in FIG. 2, as compared to nine clock cycles in the prior art. Another advantage for the scheme of the present invention is that the number of clock-cycle required for computing y(n) is irrelevant to the coefficients, while the number of clock-cycle of the prior art is proportional to the complexity of the coefficients.

In addition to being much faster than the prior art, the parallel structure of FIG. 2 is also ideal for “programmable” coefficients. The hardware structure depicted in FIG. 2 can perform as different IIR filters, with inputs having different settings. This is particularly useful for high-order IIR filters.

Assuming implementation of a seventh-order IIR filter running at a clock rate of clk, this filter is comprised of three second-order and one first-order IIR filters as shown in FIG. 3. By using the scheme in accordance with the present invention, the filter can be run at a clock rate of four times clk. Therefore, the seventh-order filter is now implemented by only one second order filter preceded by a decoder as shown in FIG. 4. Within one clk, the decoder sequentially sets the values of the Wi1,Wi2, i=0, 1, . . . 5 to the four cascaded filter coefficients. Therefore, the seventh-order filter is implemented by a second order filter on a time sharing basis. A seventh-order filter is synthesized in accordance with the present invention with an area reduction of fifty percent. It should be understood that the seventh order filter can also be synthesized reusing a second order filter on a time sharing basis in the manner discussed with reference to FIG. 4 and one first order filter.

With reference to FIG. 5, there is shown the circuit of FIG. 4 with input to and output therefrom as well as the timing diagram therefor. The output y(n) is fed back to the input of eight cascaded D flip flops which are clocked in accordance with clk1 such that the signal y(n) is transferred from D flip flop to D flip flop for each clk1 signal. The y(n) signal is delayed by four clk1 signals whereupon it is fed back to the circuit of FIG. 2 as signal y(n−1) from the fourth of the cascaded D flip flops. Also, the signal is delayed by eight clk signals whereupon it is fed back to the circuit of FIG. 2 as signal y(n−2) from the eighth of the cascaded D flip flops. Meanwhile, the output D flip flop is clocked by clk2 which operates at one fourth the speed of clk1 to provide an output from the D flip flop at every fourth clk1 signal. In the first cycle of CLK1, the first 2nd-order IIR filtering in FIG. 3 takes place; in the second cycle of CLK1, the second 2nd-order IIR filtering takes place; in the third cycle of CLK1, the third 2nd-order IIR filtering takes place; in the fourth cycle of CLK1, the fourth 1st-order IIR filtering takes place. The output is sampled at the rising edge of CLK2, which is the end of the fourth cycle of CLK1, when the input has gone through all four of the lower-order filters (three second order and one first order). In this way, the circuit of FIG. 2 is reused and thereby reduces the amount of circuitry required to implement the high-order IIR filter.

Accordingly, in accordance with the present invention, a novel parallel structure for an IIR filter is provided which is at least twice as fast as the prior art due to the parallel structure. In addition, the parallel structure is ideal for programmable coefficients. Therefore, a high-order IIR filter can be implemented by reusing a low-order filter on a time sharing basis and, consequently save large amounts of semiconductor area on a semiconductor chip on which the filter is fabricated. Comparing the parallel implementation of the subject invention with the prior art for a seventh-order IIR filter, as an example, the gate count for the subject implementation is 5379 whereas the gate count for the prior art is 10707, thereby providing an approximately 50 percent saving in chip area.

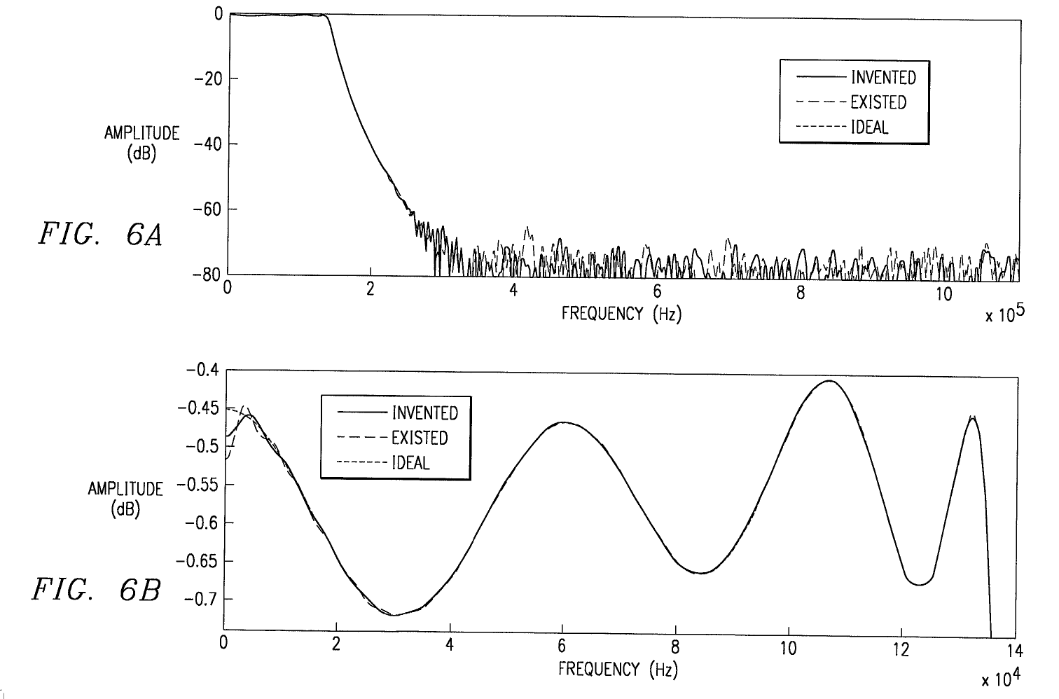

FIG. 6 is a comparison of the performance of the impulse response between the subject invention and a prior art implementation. The bottom plot shows the zoomed region in the low-frequency region, from which the implementation in accordance with the present invention can be seen to be closer to the ideal response, especially at the DC (frequencies close to zero) region.

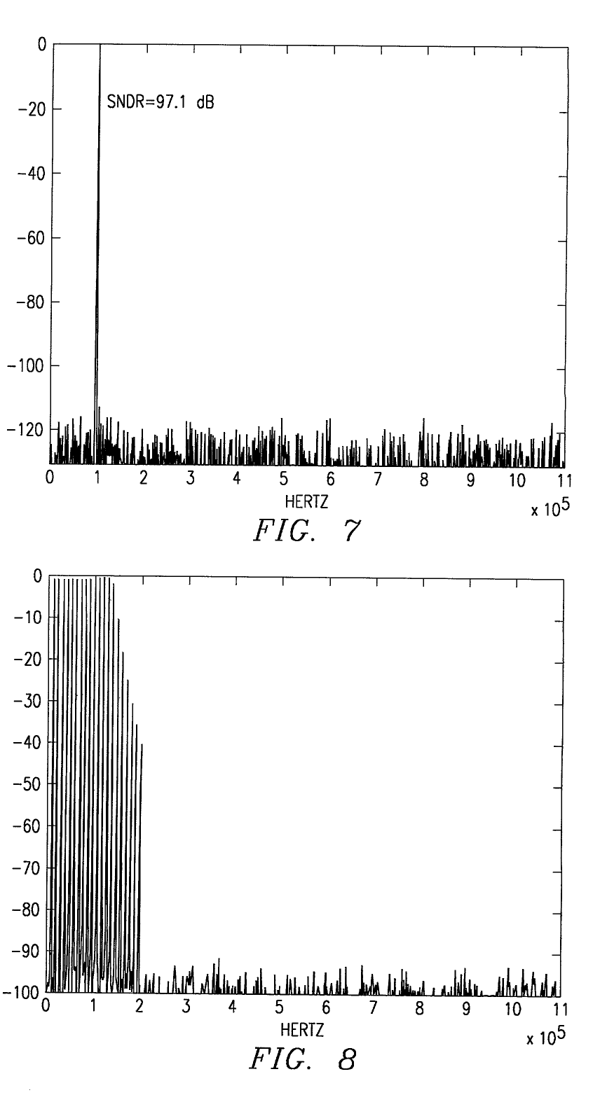

FIG. 7 is a graph of frequency response of a single tone. A signal-to-noise plus distortion ration (SNDR) of 97.1 dB is achieved. This value is adequately high for a 16-bit register length.

FIG. 8 is a graph of the frequency response of a discrete multi-tone (DMT). It can be seen that the response shape is as expected.

Though the invention has been described with respect to a specific preferred embodiment thereof, many variations and modifications will immediately become apparent to those skilled in the art. It is therefore the intention that the appended claims be interpreted as broadly as possible in view of the prior art to include all such variations and modification.

1. A method of implementing an n-th order IIR filter which comprises the steps of:
providing an IIR filter of order less than n; and
operating said IIR filter of order less than n on a time-sharing basis a plurality of times such that said plurality of times multiplied by the order of said IIR filter of order less than n is equal to or greater than n.

2. The method of claim 1 wherein said plurality of times multiplied by said order is equal to n.

3. The method of claim 1 further including providing a decoder coupled to said input terminal.

4. The method of claim 2 further including a providing decoder coupled to said input terminal.

5. An implementstion of an n-th order IIR filter which comprises:
an IIR filter of order less than n; and
means to operate said IIR filter of order less than n on a time-sharing basis a plurality of times such that said plurality of times multiplied by the order of said IIR filter of order less than n is equal to or greater than n.

6. The implementation of claim 5 wherein said plurality of times multiplied by said order is equal to n.

7. The implementation of claim 5 further including a decoder coupled to said input terminal.

8. The implementation of claim 6 further including a decoder coupled to said input terminal.
